(19) United States
(12) Patent Application Publication
(10) Pub. No.: US 2014/0109216 A1
(43) Pub. Date: Apr. 17, 2014

(54) PORTABLE PERSONAL INFORMATION STORAGE DEVICE

(71) Applicant: Sverre Iversen, Bothell, WA (US)

(72) Inventor: Sverre Iversen, Bothell, WA (US)

(21) Appl. No.: 13/650,530

(22) Filed: Oct. 12, 2012

(51) Int. Cl. G06F 21/31

(52) U.S. Cl. CPC G06F 21/31
USPC 726/17

(57) ABSTRACT

A personal information storage system includes a securely configured portable media storage device that communicates with a computer to receive selected personal information. In one embodiment, the portable media storage device takes the form of a universal serial bus connector having a proprietary identifier embedded into the readable memory of the device. A program on the computer restricts the personal information residing on the computer's memory from being accessed by any other storage or processing device except for the secure portable media storage device. Moreover, the portable media storage device may include one or more inaccessible memory portions to prevent the storage of irrelevant material onto the device.

### PRIORITY CLAIM

This utility patent application claims priority from U.S. patent application Ser. No. 12/803,596 filed on Jun. 29, 2010, and wherein the subject matter of the same is incorporated herein by reference in its entirety.

### FIELD OF THE INVENTION

This invention relates to portable personal safety devices and particularly to portable personal safety devices that have emergency document storage that utilize digital memory.

### BACKGROUND

People have many important documents, ranging from personal identification papers, passports, and driver's licenses. Some can be life saving; these include emergency contact information, medical histories or conditions, blood type, donor information and so on. Others include important legal documents such as; a Health Care Directive, a Living Will, Power of Attorney, Last Will & Testament, and perhaps even a small video clip of final messages to loved ones. Unfortunately, these documents are usually kept locked away in many different locations, inaccessible at time of need. People do not usually carry these documents with them. However, if they did, it could be a lifesaver.

### SUMMARY OF THE INVENTION

An embodiment of the present invention includes a portable and accessible personal information system that includes a portable memory storage device (or equivalent) located within, pivotable into and out of, or extending from a housing. The personal information system is intended to be worn by a user or available to the user at all times. The personal information system may be worn on the outside of clothing at night as a safety reflector. The personal information system may include an on/off switch for a LED strobe or fixed light configuration. The personal information system stores personal information that may be quickly accessible by a first responder during an emergency situation. The user may selectively password protect certain information or designate some information as “read only.” Thus, in case of an emergency, a first responder such as an emergency medical technician (EMT), doctor, paramedic, nurse, etc. can access the personal information, verify the user by comparing some of the personal information to pertinent information in the user's possession such as a picture ID, (not unlike a drivers license for verification of person), and obtain a complete medical history, blood type, prescription medication, allergies, diabetic, donor information etc. along with emergency contact information to the extent this information has been kept current by the user.

In another embodiment of the present invention, a personal information system includes a computer station having a graphical user interface for inputting personal information to a secure database and further having a processor for managing a plurality of digital forms based on commands input by a user, wherein the personal information is selectively input by the user and the digital forms are viewable by the user via the graphical user interface; and a portable media storage device having a housing coupled to a memory storage device, which includes a memory storage capacity for receiving the personal information stored in the database of the computer station, the memory storage device is encrypted to communicate with only the secure database, wherein an amount of the memory storage capacity is configured to be inaccessible for receiving information that is not the personal information from the secure database. In addition, at least some of the personal information stored on the memory storage device is accessible by a health care provider during an emergency situation.

In yet another embodiment of the present invention, a method for making a portable memory storage device for use during an emergency situation includes the steps of (1) configuring a portable memory storage device to receive user-selected personal information downloaded from a secure database of a selected computer, wherein configuring the portable memory storage device includes encrypting the device to be recognizable by the selected computer and restricting the device to receive information solely from the secure database; and (2) configuring the portable memory storage device to store the information in an accessible memory portion of a memory of the portable memory storage device, wherein a total memory of the portable memory storage device includes the accessible memory portion and a non-accessible memory portion.

### BRIEF DESCRIPTION OF THE DRAWINGS

Preferred and alternative embodiments of the present invention are described in detail below with reference to the following drawings:

FIG. 1 is detail view of one embodiment of the invention.

FIG. 1A is a front view of a second embodiment of the invention.

FIG. 1B is a rear perspective view of the second embodiment of the invention.

FIG. 2 is a detail of a computer showing the storage device installed to transfer files.

FIG. 3 is an interior view of the first embodiment showing the layout of the major components.

FIG. 4 is a view of the circuit board configuration for the first embodiment.

FIG. 5A is an electrical schematic diagram of the operating circuit for the device.

FIG. 5B is an electrical schematic diagram of the operating circuit for the device.

FIG. 5C is a top plan view showing LED placements within the device.

FIG. 5D is an electrical schematic diagram of the operating circuit for the device.

FIG. 6A is a diagram of a first LED operating pattern developed by the device.

FIG. 6B is a diagram of a second LED operating pattern developed by the device.

FIG. 6C is a diagram of a third LED operating pattern developed by the device.

FIG. 7 is a screenshot of the desktop for the program.

FIG. 8 is a screenshot of the language tool tip.

FIG. 9 is a screenshot of the personal profile details page.

FIG. 10 is a screenshot of the health profile page.

FIG. 11 is a screenshot of the family health history page showing an initial entry.

FIG. 12 is a screenshot of the family health history page showing a pull down menu for other family member choices.

FIG. 13 is a screenshot of the primary health insurance page.

FIG. 14 is a screenshot of the primary health care supplemental information window.

FIG. 15 is a screenshot of the secondary health insurance page.

FIG. 16 is a screenshot of the government health insurance page.

FIG. 17 is a screenshot of the disability insurance page.

FIG. 18 is a screenshot of the notes page.

FIG. 19 is a screenshot of the patient health profile showing a selection tool tip.

FIG. 20 is a screenshot of the patient health profile showing a pull down calendar window.

FIG. 21 is a screenshot of the patient health profile showing a second selection tool tip.

FIG. 22 is a schematic system diagram for a personal information storage system with a portable media storage device in communication with a computer according to an embodiment of the present invention.

### DETAILED DESCRIPTION

In the following description, certain specific details are set forth in order to provide a thorough understanding of various embodiments of the invention. However, one skilled in the art will understand that the invention may be practiced without these details. In other instances, well-known structures associated with media storage devices, computers, graphical user interfaces and methods of using the same have not necessarily been shown or described in detail to avoid unnecessarily obscuring descriptions of the embodiments of the invention.

The present invention is generally directed toward a personal information storage system having a securely configured portable media storage device that communicates with a computer to receive selected personal information such as, but not limited to, medical and health information, emergency contact information, etc. In one embodiment, the portable media storage device takes the form of a universal serial bus connector having a proprietary identifier embedded into the readable memory of the device. A program on the computer restricts the personal information residing on the computer's memory from being accessed by any other storage or processing device except for the secure portable media storage device. Further to another embodiment of the present invention, the portable media storage device includes one or more inaccessible memory portions to prevent the storage of irrelevant material onto the device.

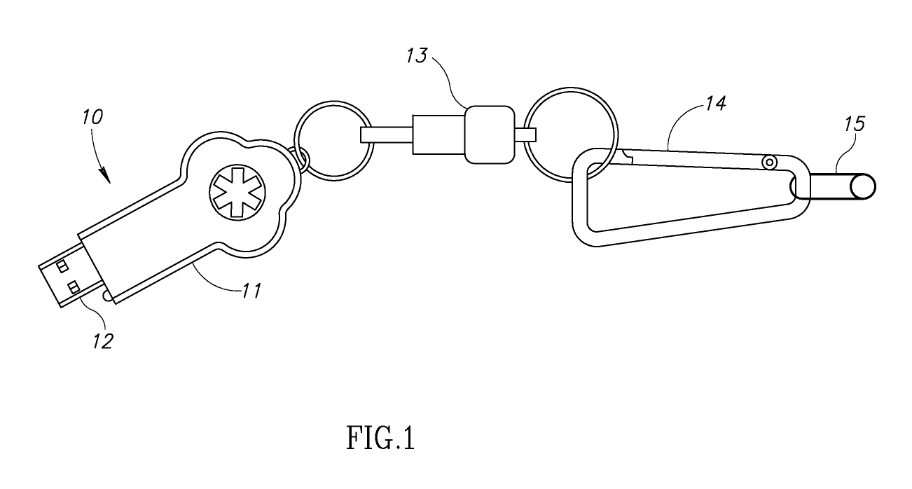

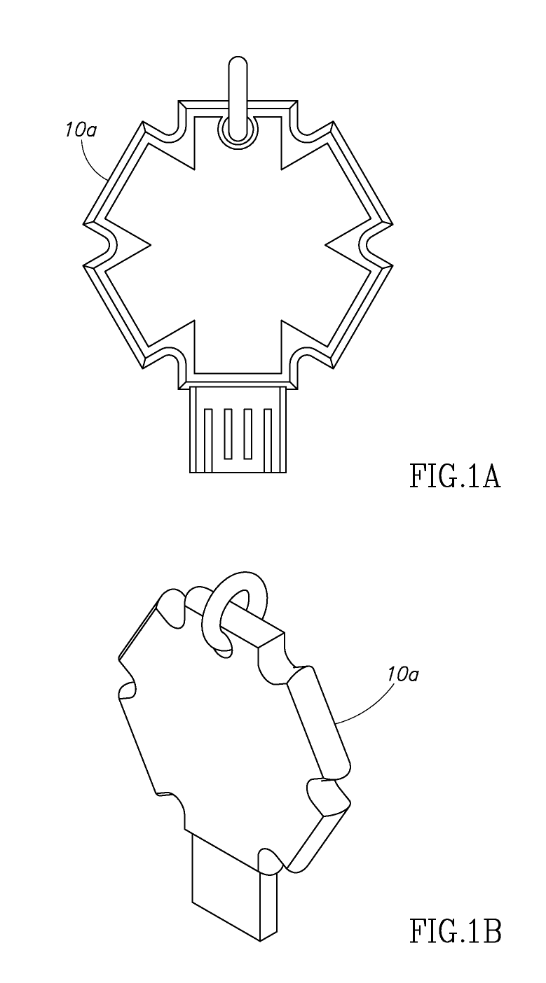

Referring now to FIG. 1, a detail view of the first embodiment of the invention with all components is shown. In its full form, the personal safety device has a number of components. The first is a 1-gigabyte memory stick flash drive that is housed in a plastic case 10 that has a built in reflecting coating 11. The memory stick has a computer USB connector 12 at one end that enables it to connect to a computer. The other end of the memory stick is attached to a 2-part detachable keychain 13. The other end of the keychain is attached to a carabineer clip 14. Attached to the carabineer is a safety pin 15 or small binder clip (not shown).

The light reflective housing for the flash drive is intended to be worn by a user at night to aid in visibility for drivers. The different clips are used to enable the device to be attached to clothing, bicycles, belt loops, etc. as desired. In this way, the user is likely to wear the safety device when it is needed.

In the preferred embodiment, the housing is water resistant. It is designed to survive a drop test of 3 feet or less on hard surfaces without damage to the Flash Drive. The housing can be of rubberized type material for easy attachment and grasping. The housing is made of an ABS like material for durability. Color of the unit can vary. The lenses are clear polycarbonate, although the other parts of the housing have opaque texture to spread out internal light.

While FIG. 1 shows the preferred form of the invention, the invention can be made ion other shapes. FIGS. 1A and 1B show second embodiment of the invention 10a. In this embodiment, the case is made shorter. Obviously, the circuit board must be modified for this shape, but that is well within the abilities of those of ordinary skill in the art. The second embodiment can be used with pets, as discussed below, as well. Finally, the device can be made in many different shapes. However, the discussion below concentrates on the embodiment of FIG. 1, with the knowledge that changes to the shape require modifications to the circuit construction that are easily made.

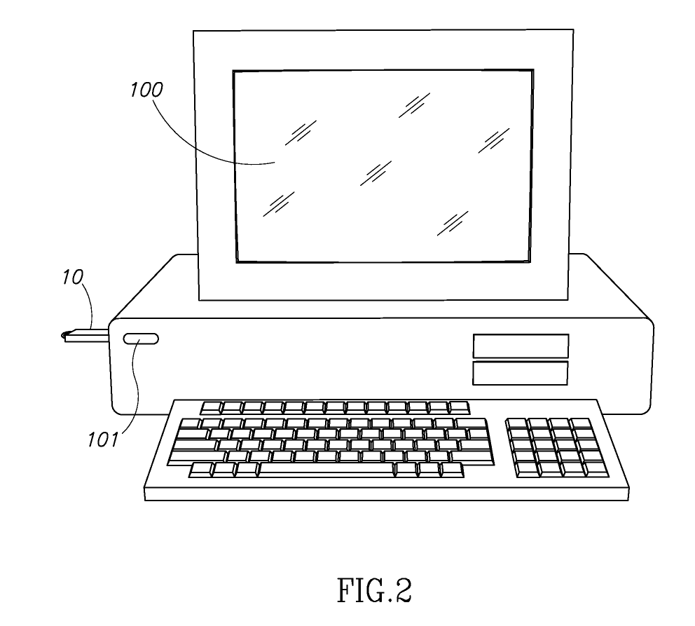

FIG. 2 is a detail of a computer showing the storage device installed to transfer files. In this figure, a typical computer 100 is shown. The computer has a number of USB ports 101 located on the housing. The memory stick 10 is shown plugged into one of the ports on the computer.

The memory stick is designed to carry key information files about a user so that this information is available in cases of emergency. Some of this information is readily accessible, such as emergency medical information as read only files. The remainder of the information is protected by an encrypted password or person code that is known only to the user. A trusted person, such as the user's spouse, family or attorney, may also keep the code. The code allows only the user to access some files and to change the information on all files. For example, in case of an emergency, a non owner such as an Emergency Medical Technician, Doctor, Paramedic, Nurse, etc. can access the data and open the emergency file and (read only) all the pertinent information on that individual, such as a picture ID (not unlike a drivers license) medical history, blood type, prescription medication, allergies, etc. along with emergency contact information.

It is up to the user to choose the individual files that would be accessible and which files you would have a security code to open, bank and credit card information, for example. Another non-owner user could be a receptionist at a doctors or dentist or any health care providers office, for pre-registration, where they could open a (read only) file on the owners healthcare insurance provider and any up to date medical information. This would enable the receptionist to open the file and just print out the desired information, thus saving the patient and the receptionist valuable time in an emergency or just a routine check in process.

The device is a handheld LED flashlight and signaling device combined with a USB drive. The USB drive portion of the device can be OEMed, if appropriate. A dedicated MCU on the device controls the flashlight and signaling LEDs and monitors two pushbuttons for user interaction.

The device provides signaling by rapidly flashing a set of eight LEDs in one of several selectable patterns.

Device powers LEDs from an internal battery; the battery is automatically recharged when the device is plugged into a powered USB hub or PC connection.

Internal battery must provide maximum duration of continuous flashing before needing a recharge. Standby current (signaling and flashlight LEDs dark) must be at absolute minimum to prolong battery life.

USB drive must retain full data integrity regardless of the charge state of the internal battery used by the flashlight and signaling circuitry.

The user can select different flashing patterns using a dedicated pushbutton switch on the device (signaling pushbutton). The user can control the on/off/dim state of the flashlight LED using a dedicated pushbutton switch on the device (flashlight pushbutton).

The device is normally always powered, as the battery that powers the MCU is always connected. In the event that the battery is discharged and the user plugs the device into a USB hub to recharge, the device should power up with the signaling and flashlight LEDs off.

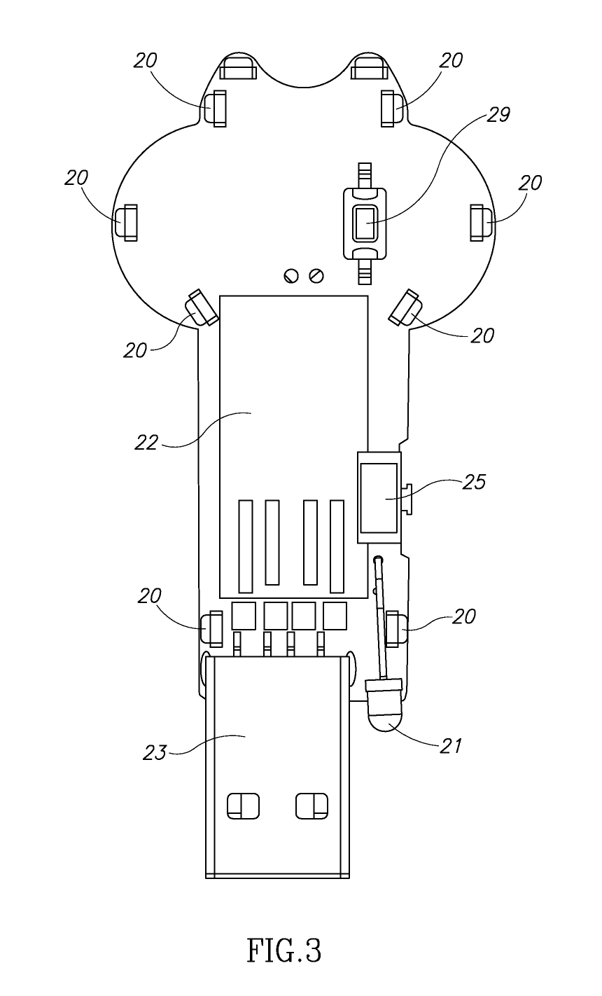

FIG. 3 is a diagram of the major parts as laid out on the circuit board shaped for the first embodiment. Here, the position of the LEDs 20 is shown. The LED flashlight 21 is located near the end of the device as shown. FIG. 3 also shows the placement of other key components. The USB flash drive 22 is positioned as shown. It is electrically connected to the USB connector 23 located at the base of the key. A first pushbutton switch 24 is positioned as shown. This switch is used to turn the device on and off and to change the pattern of the blinking LEDs, as discussed below. A second pushbutton switch 25 is positioned on the side of the of the housing. It is used to control the flashlight LED, as discussed below.

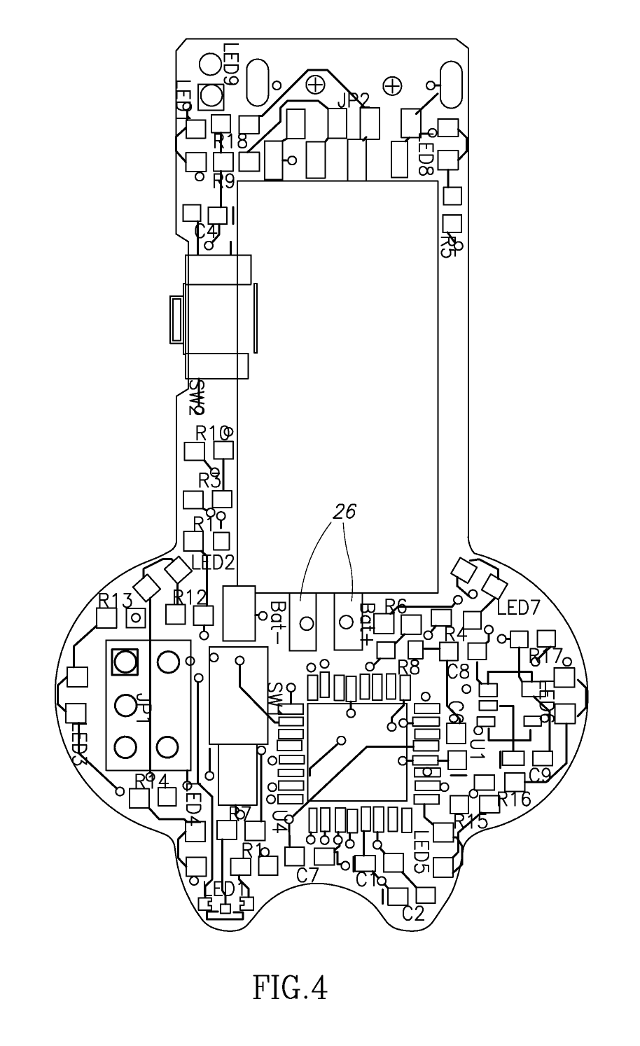

FIG. 4 is a view of the circuit board configuration for the first embodiment. Here, the layout of the major parts is shown. Of course, this design can be changed in any number of ways and is representative of one parts arrangement.

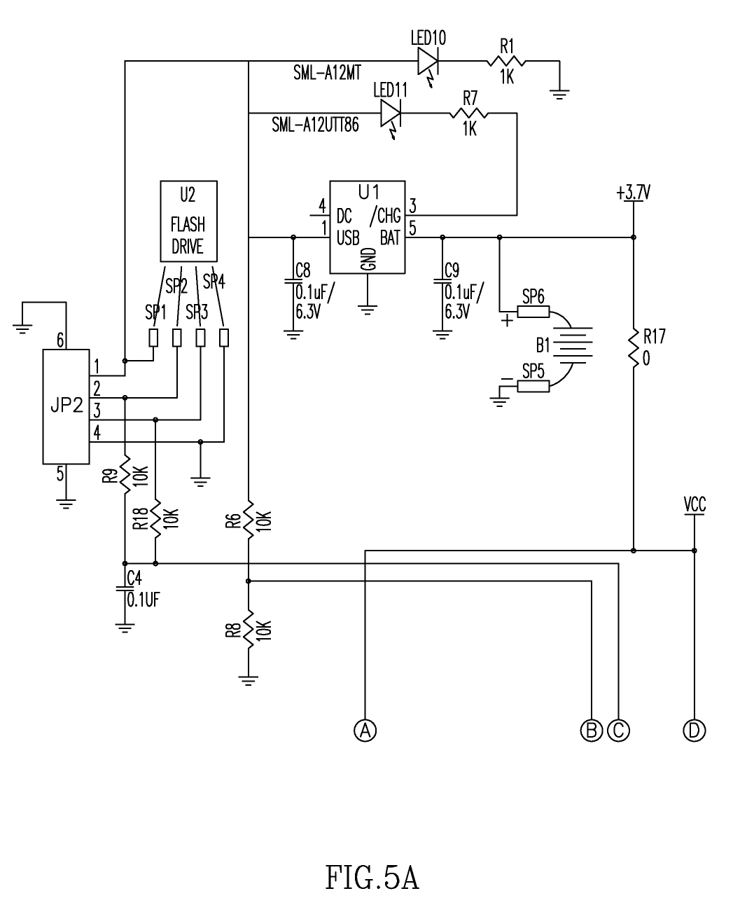

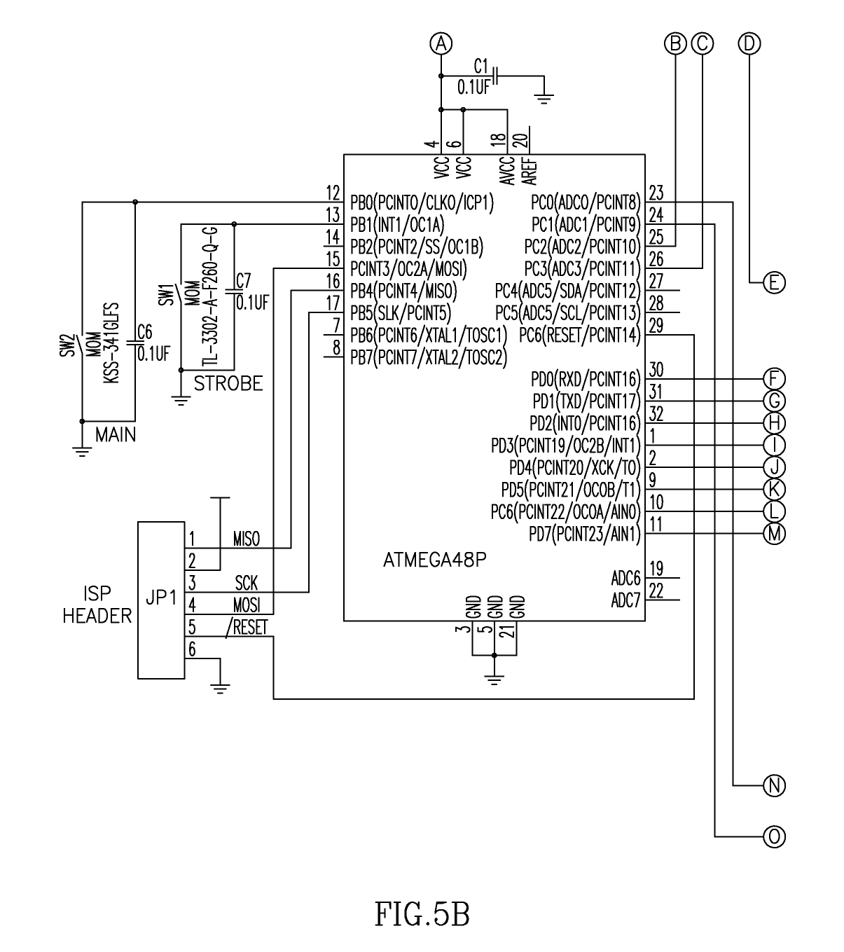

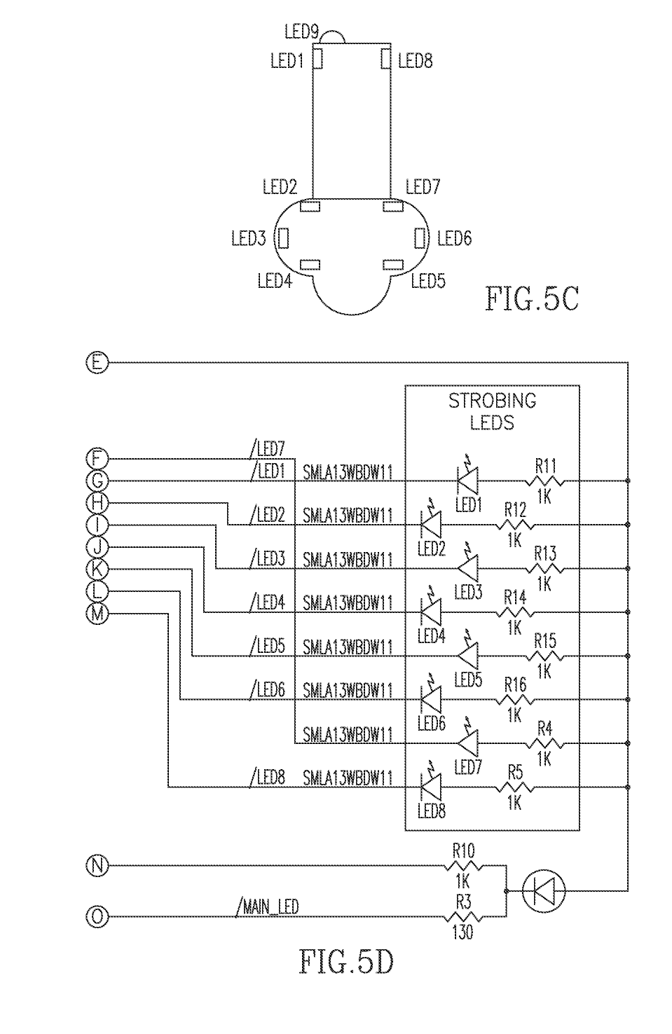

FIGS. 5A, 5B AND 5D show electrical schematic diagrams of the operating circuit for the device. These diagrams show the electrical connections for the device as well as the major components. These diagrams correspond to the circuit board configuration of FIG. 4. FIG. 5C shows a top, plan view of the device indicating locations for the LEDs.

Based on the circuit diagram above, the following sections describe the electronics design elements that will meet the product's requirements.

In the preferred embodiment the battery 26 is 3.7V rechargeable lithium with a 100 mAH capacity. The battery charges when the device is plugged into any powered USB port. Charging current is held below 100 mA so any compliant USB port will provide adequate power. Battery charging is performed in a protected manner to prolong battery life and avoid damage to the battery. The charging circuit is designed to have minimal drain on the battery when it is not connected to powered USB port.

A USB power and battery charge indicator is a pair of colored LEDs 10 and 11. When plugged into a powered USB plug, the green LED will light. While charging, the red LED is lit.

The flash drive, in the preferred embodiment is a thumb drive. The electronics are included in the package, and are electrically independent of charging circuit, battery, and LED control circuitry. The thumb drive is powered from a +5V and ground that are tapped off the USB connector of the thumb drive to provide charging for the battery. In the preferred embodiment, the connections to the USB connector comply with the USB2 specification.

In the preferred embodiment, as discussed above, several LEDs are used. The strobe and flashlight LEDs are white. LEDs operate down to nominal 3V to allow operation directly from the battery. Strobe LEDs are side-firing to allow maximum viewing angle. In the preferred embodiment, the flashlight LED viewing angle is 40 degrees nominal to allow concentrated flashlight-type emission. All of the LEDs are high efficiency to maximize battery life.

In the preferred embodiment the Printed Wiring Board (PWB) is a type FR4. It has a thickness of 0.063 inches with 2 oz copper added; a hot air solder leveling (HASL) finish and green solder mask with white silkscreen are used. The Board has four layers to provide adequate ground/power distribution and signal routing area. Solder pads are provided to terminate battery and USB power connections. Components are surface-mount to minimize circuit size. Components are mounted to the topside only to minimize assembly height.

The following sections describe the firmware design elements that will meet the product's requirements. In the preferred embodiment, the device uses an Atmel ATmega48P available from the Atmel Corporation, San Jose, Calif. This is a low-power microcontroller unit (MCU) running custom firmware. The MCU uses its internal 8 MHz RC oscillator. No external crystal or timing electronics are used. Note as this application is not timing-critical and it will not be necessary to adjust the RC timing registers.

At Production time, the fuses for the MCU must be set as described below. A fuse is ON if the associated box in the Fuses window of the AVRStudio4 programming display is checked; a fuse is OFF if the associated box is not checked.

| Fuse name | Setting |
|---|---|
| BODLEVEL | OFF (Disable brown-out detect) |
| RSTDISBL | OFF (Do not disable reset) |
| DWEN | OFF |
| SPIEN | ON (SPI download enable) |
| WDTON | OFF (Disable watchdog timer) |
| EESAVE | OFF (Do not save EEPROM contents across |
| | firmware download) |
| BOOTSZ | 256 words |
| BOOTRST | OFF (Do not use bootloader reset vectors) |
| CKDIV8 | OFF (Do not divide MCU clock by 8) |
| CKOUT | OFF (Do not provide MCU clock on I/O pin) |
| SUT_CKSEL | Internal RC Oscillator = 8 MHz; |
| | start-up time PWRDWN/RESET: |
| | 6CK/14CK + 65 msecs. |

The above fuse settings can also be set from the command line with the appropriate PC software and programming pod. To do so, modify the MCU fuses to write 0xFF to the Extended fuses, 0xDF to the High fuses, and 0xE2 to the Low fuses.

As discussed above, the device has eight LEDs for signaling. The user selects the displayed signaling pattern by repeatedly pressing the signaling pushbutton to cycle through the available patterns.

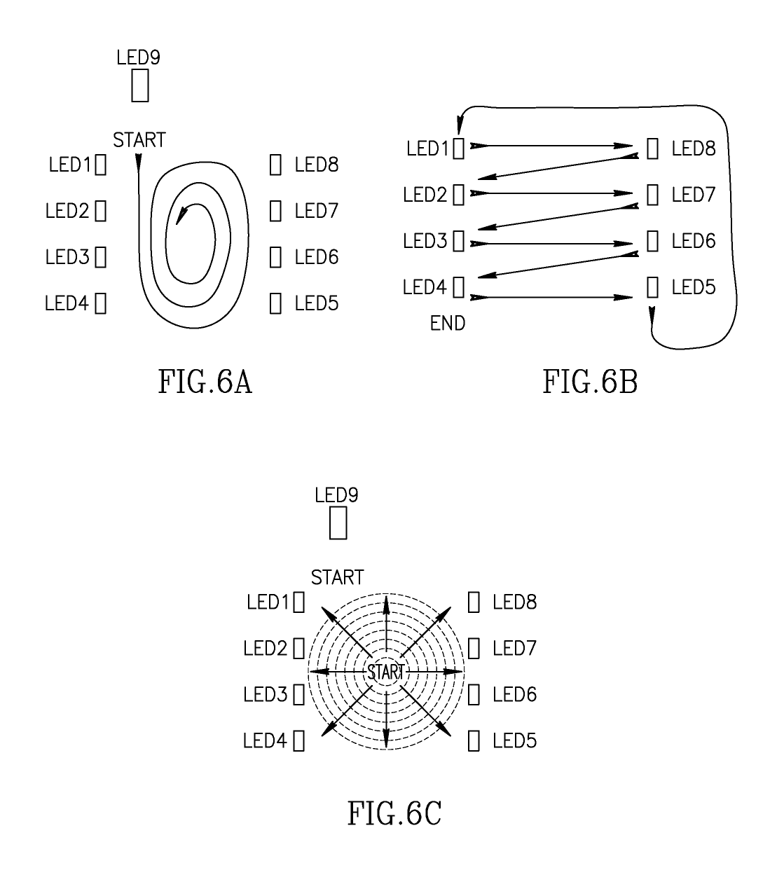

The device provides the following set of LED blink patterns, based on user presses of the signaling pushbutton.

| Switch press | Pattern |
|---|---|
| First | Circular pattern, each LED on singly for 15 msecs, dark |
| | for rest of time slot. LEDs light in sequence. A complete |
| | cycle of all six LEDs takes 400 msecs. This is shown in |
| | FIG. 6A. |
| Second | Opposite pattern, each LED on singly for 15 msecs, dark |
| | for rest of time slot. LEDs light in the order 1, 8, 2, |
| | 7, 3, 6 and 4, 5 A complete cycle of all eight LEDs takes |
| | 400 msecs. This is shown in FIG. 6B. |
| Third | Unison pattern, all LEDs on simultaneously for 15 msecs, |
| | dark for 385 msecs. Entire on-off sequence takes |
| | 400 msecs. This is shown in FIG. 6C. |
| Fourth | All LEDs off. |

Whenever a signaling LED is on, that LED is driven at 100% by the firmware. Maximum brightness for that LED is controlled by the associated dropping resistor (see, FIG. 5D).

As discussed above, the device has a single forward-facing LED 21 for use as a flashlight. The user selects the brightness level of the LED by repeatedly pressing the flashlight pushbutton 25 to cycle through the available levels.

The device provides the following set of LED flashlight levels, based on user operation of the flashlight pushbutton.

| Switch press | Brightness level |
|---|---|
| First | Approximately 50% brightness. |
| Second | 100% brightness. |
| Third | All LEDs off. |

The flashlight LED is controlled with two parallel output lines on the MCU. Each line has a separate dropping resistor. The MCU selects the flashlight LED brightness level by turning on zero or more output lines to the flashlight LED.

In the preferred embodiment, the MCU directly reads port lines tied to the two pushbutton switches. The MCU's internal pullup resistors are on, providing voltage to the switches. The firmware provides switch debounce. The firmware also ensures that static or accidental contact with wiring to the switches does not appear to the MCU as a valid switch press. Note that part of this debounce and protection can be provided by electronics.

The firmware design keeps the MCU in power-save mode as much as possible. The MCU wakes from power-save mode whenever the user presses a button. The MCU also wakes from power-save mode if the signaling LEDs are flashing a pattern. In this case, the MCU activates the next LED in the sequence and then immediately returns to power-save mode.

Besides, the actual key, a software program is used with the base computer, as discussed above, to store and load the information about the user from the computer, where entry of the data is accomplished. The software has many different screens for collecting data. Obviously, not all screens are needed for every user, but they are available as needed.

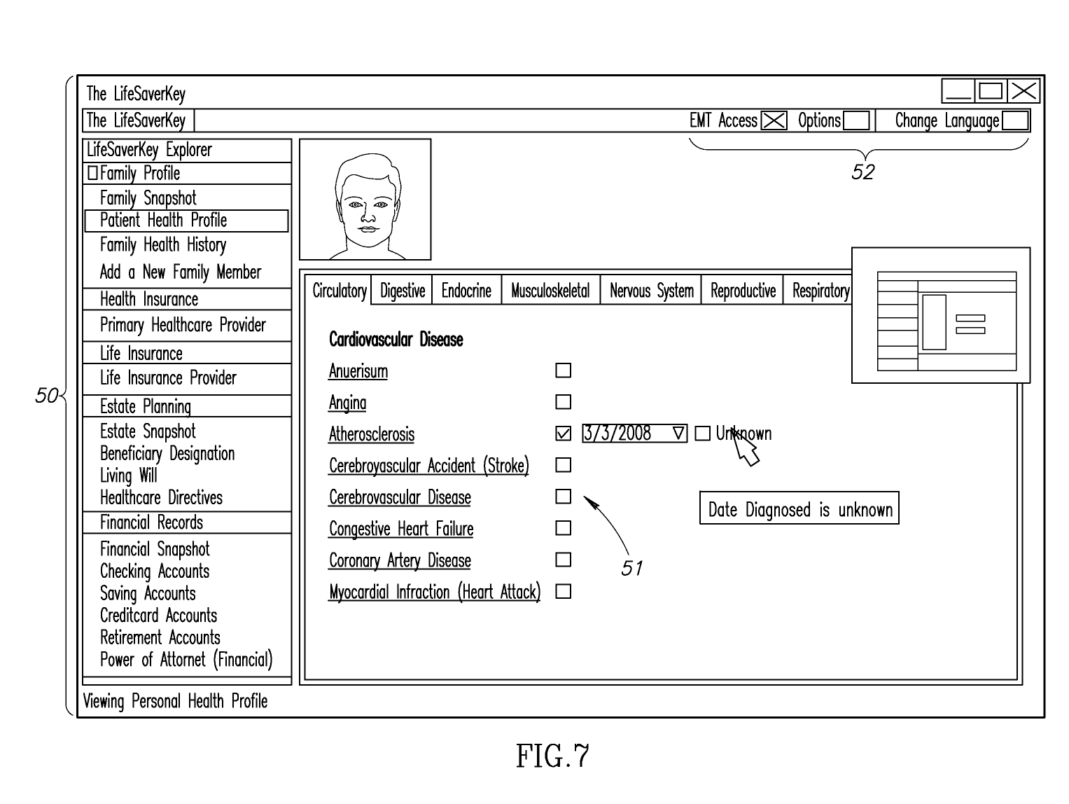

FIG. 7 is a screenshot of the desktop for the program. Here, the main menu items are shown on the left side in a list 50. In the center of the screen is a data collection zone 51. At the upper right are basic system commands 52.

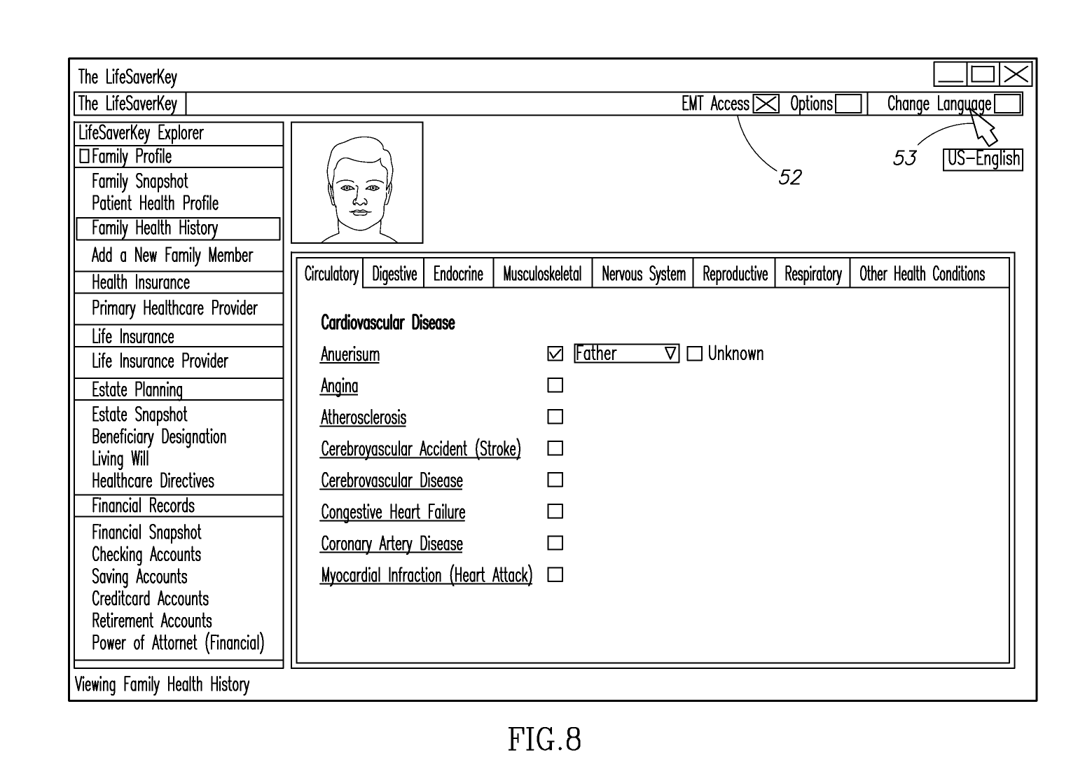

FIG. 8 is a screenshot of the language tool tip. In this figure, a cursor (tool tip) 53 is positioned on the change language icon, part of controls 52. This allows the user to select a different language.

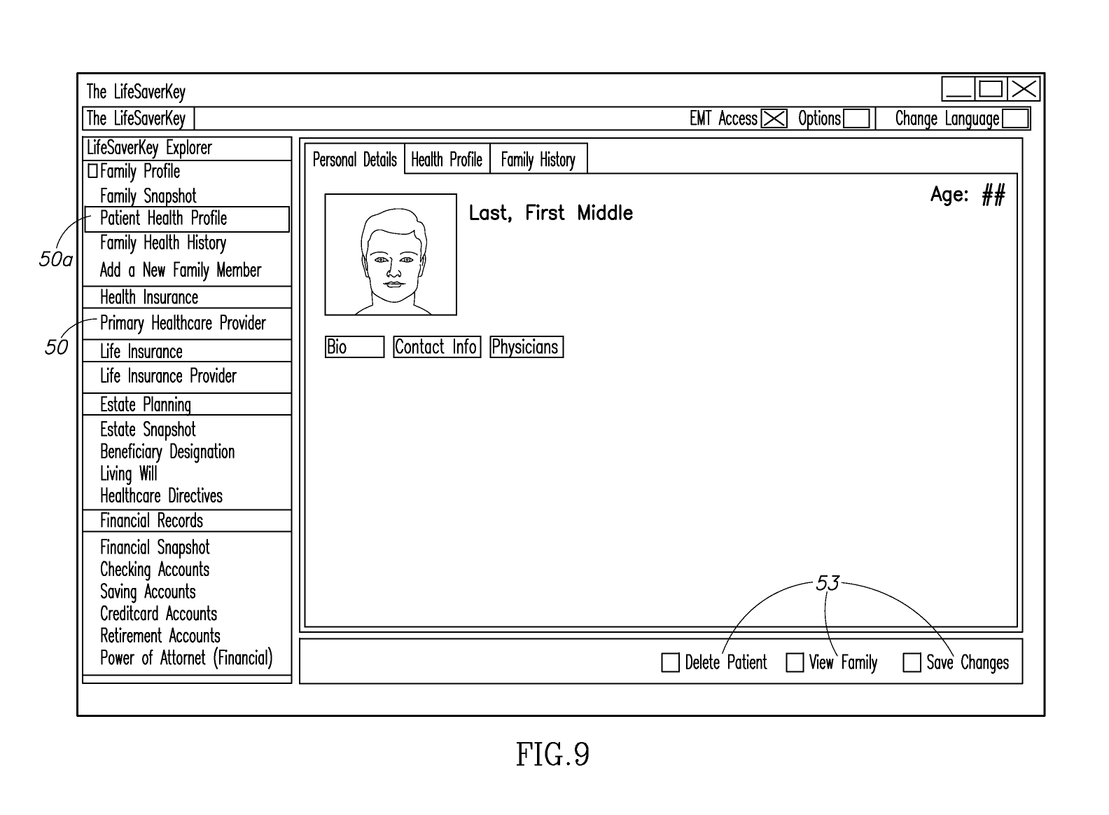

FIG. 9 is a screenshot of the personal profile details page. This FIGURE is the starting point for data collection. It is selected from the main menu 50 on the left, which shows the Patient Health Profile 50a being selected. In the data collection zone, the personal details tab is selected. Here, users enter their name and age. Sub menus allow a user to add personal information, contact information, and information about their physicians. Note, at the bottom of the screen are additional control options 53 as shown.

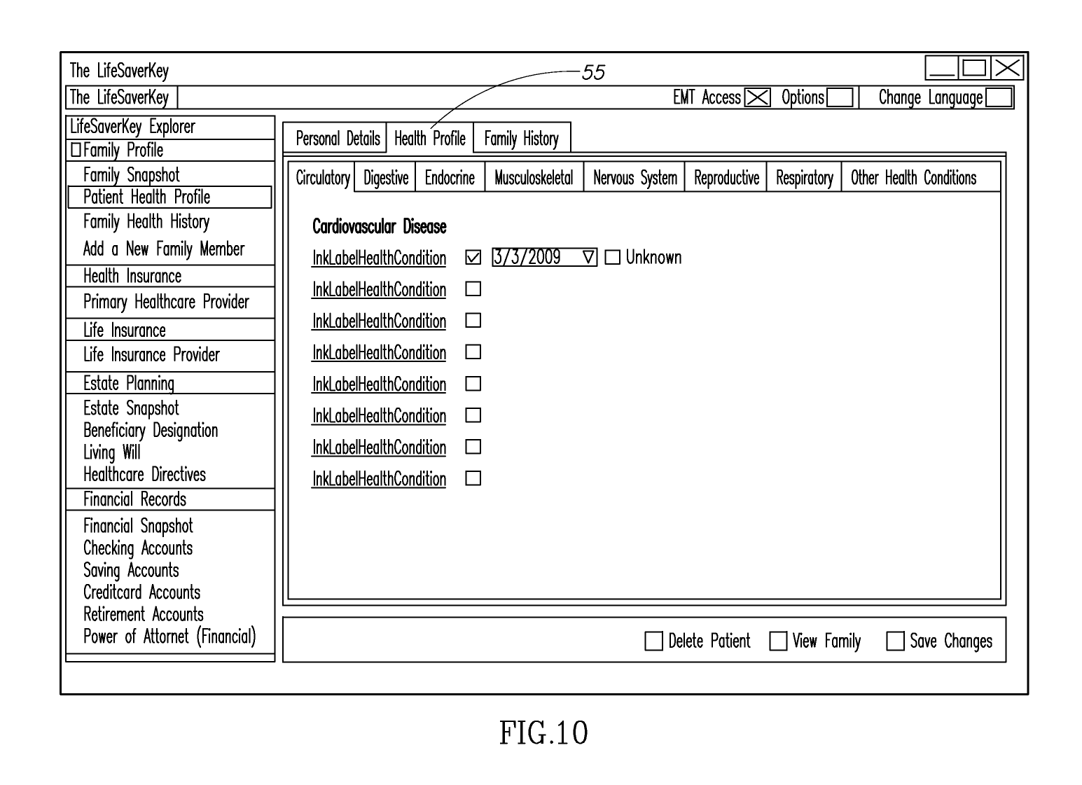

FIG. 10 is a screenshot of the health profile page. Here, the health profile tab 55 is selected. This page lets users enter information on various medical conditions they may have had. User can select a particular disease and then enter dates and other information.

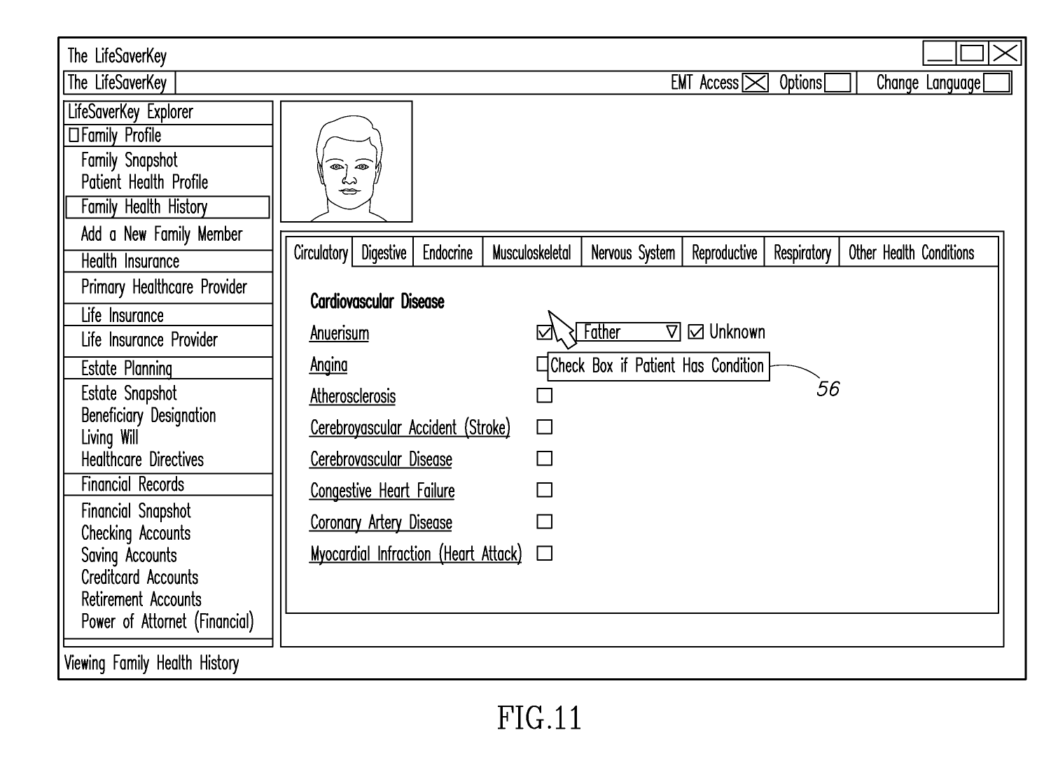

FIG. 11 is a screenshot of the family health history page showing an initial entry 56. In this screen, the user is presented with a variety of bodily systems. For each system, a menu lists a number of common diseases. This allows users to select the applicable disease information and provide the details related to it.

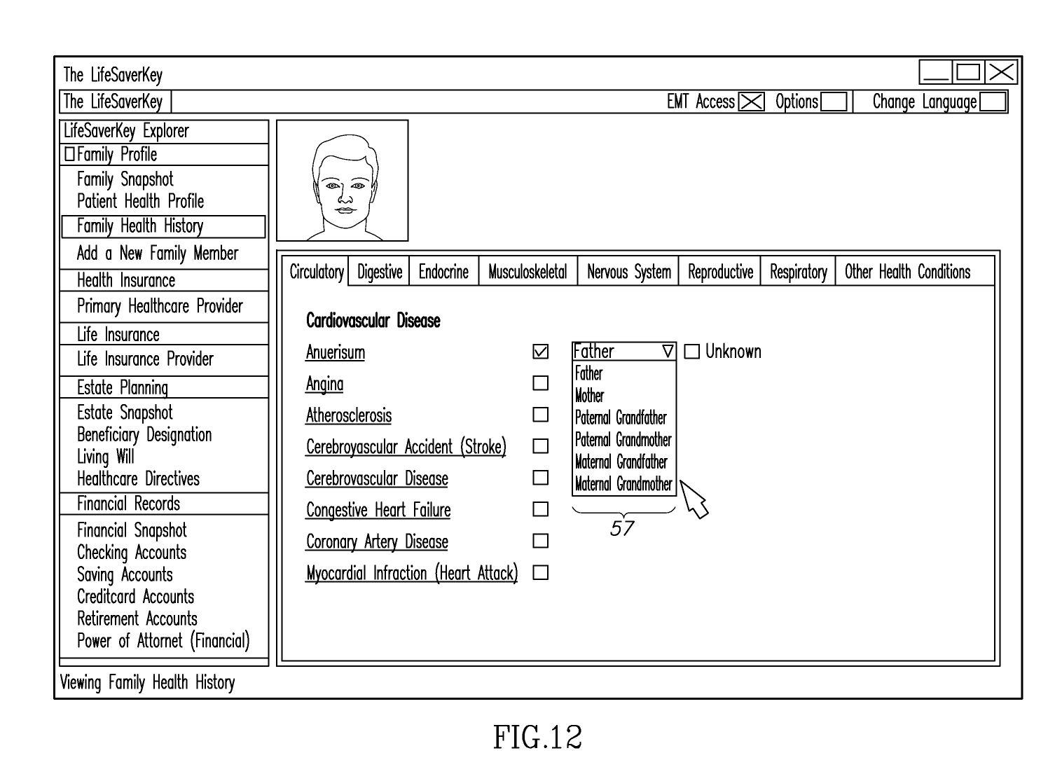

FIG. 12 is a screenshot of the family health history page showing a pull down menu 57 for other family member choices. This FIGURE is similar to that of FIG. 11 except that here, a pull down menu is provided to allow a user to select the appropriate family member that suffers from that particular aliment.

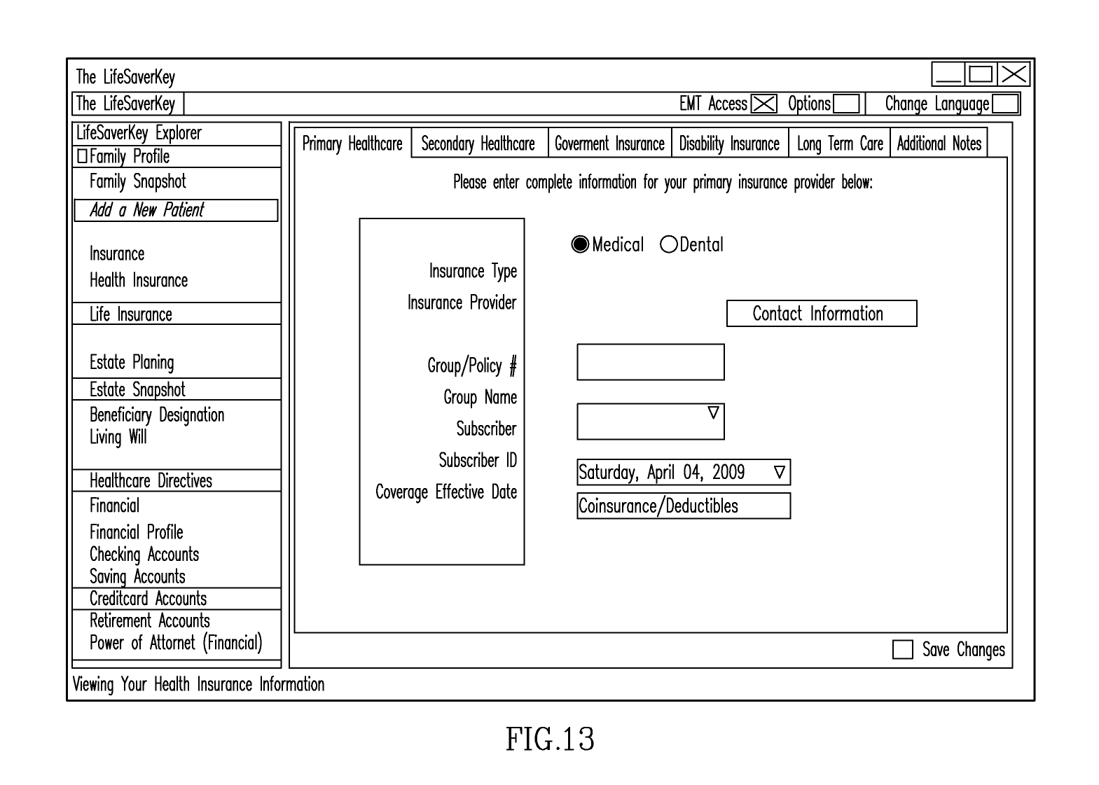

FIG. 13 is a screenshot of the primary health insurance page. In addition to medical history, the system also collects data on user's health insurance. This page shows data collection fields for primary health care insurance, including the provider's name, contact information and coverage dates.

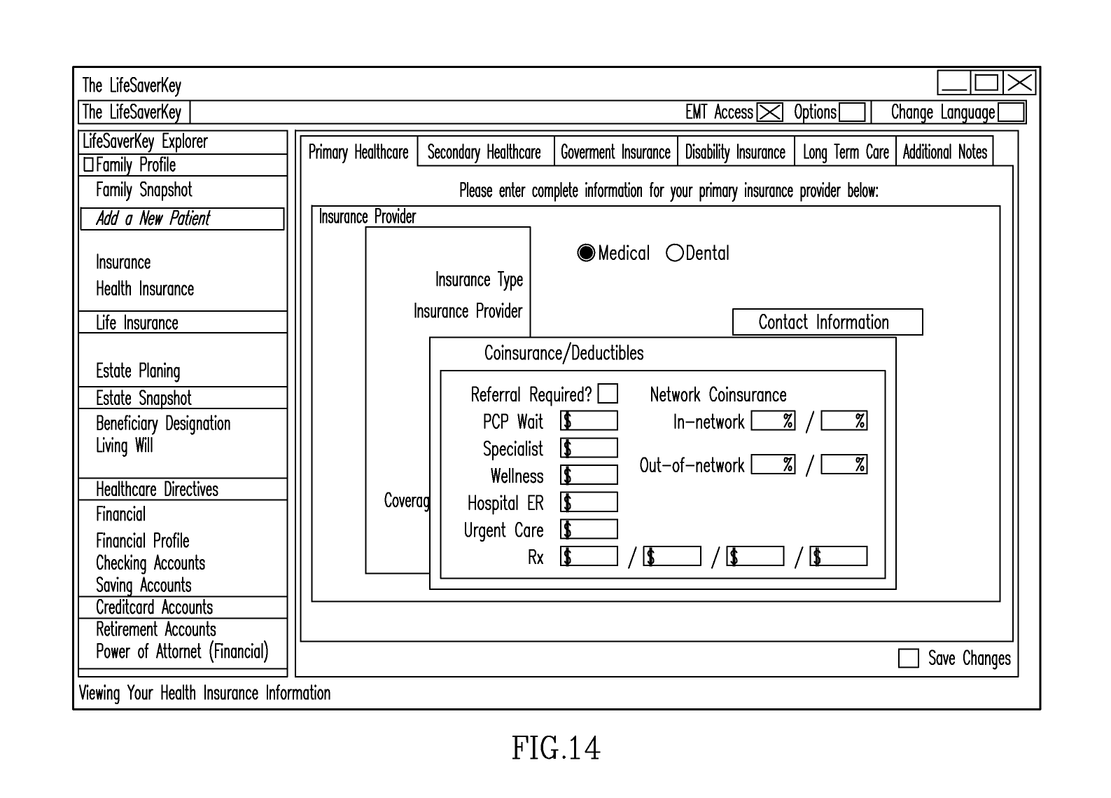

FIG. 14 is a screenshot of the primary health care supplemental information window. On this screen, a window opens that allows a user to provide information related to coinsurance and deductibles for the primary insurance.

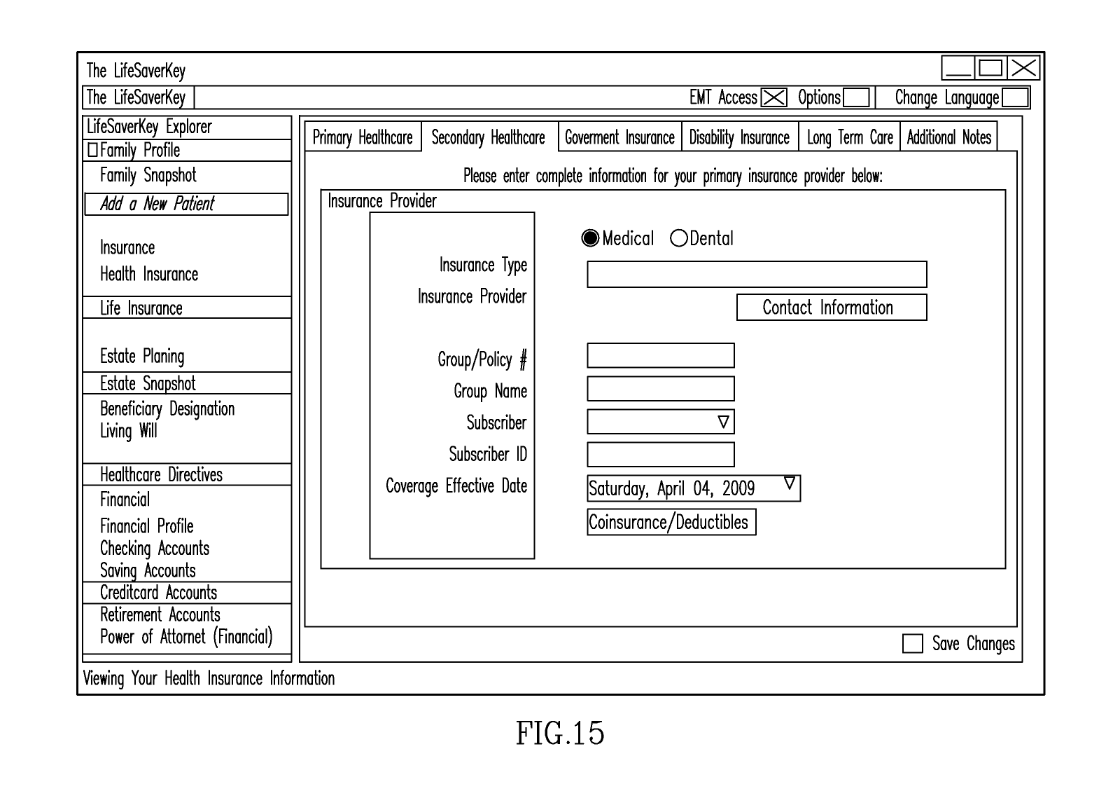

FIG. 15 is a screenshot of the secondary health insurance page. As in the case of FIG. 13, this page shows data collection fields for any secondary health care insurance, including the provider's name, contact information and coverage dates.

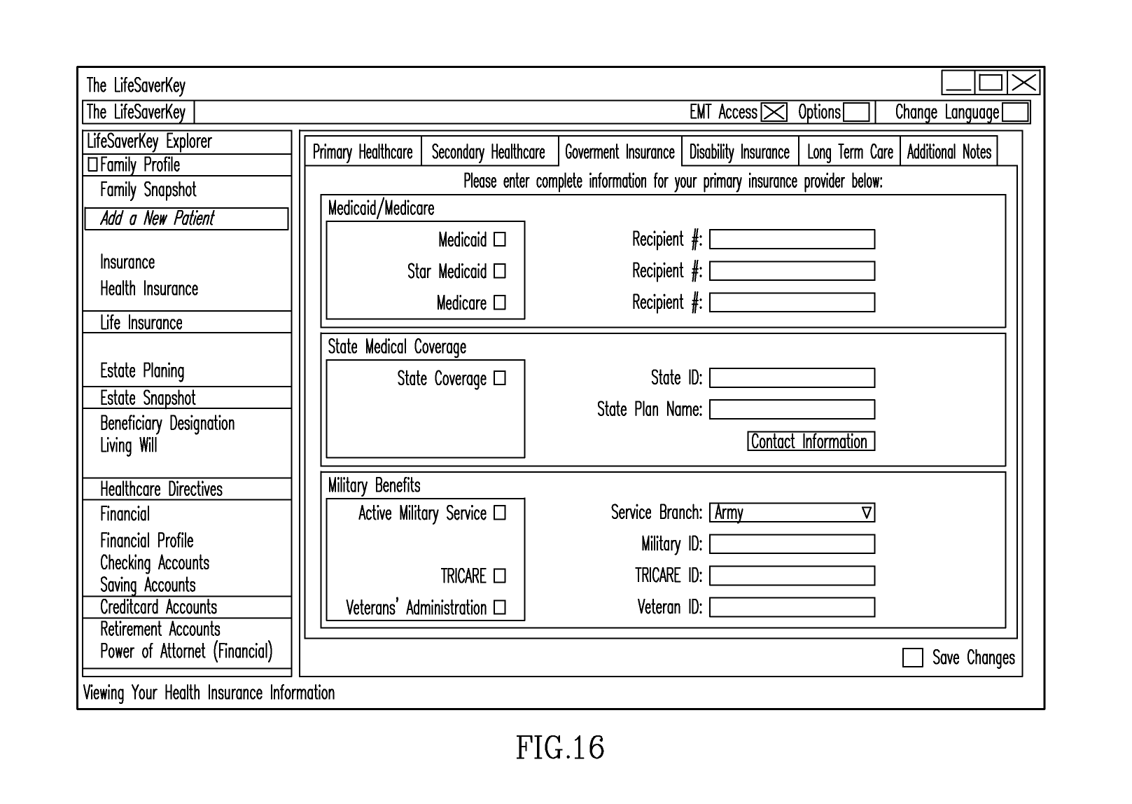

FIG. 16 is a screenshot of the government health insurance page. This page allows users to provide information on various government insurance programs they may utilize.

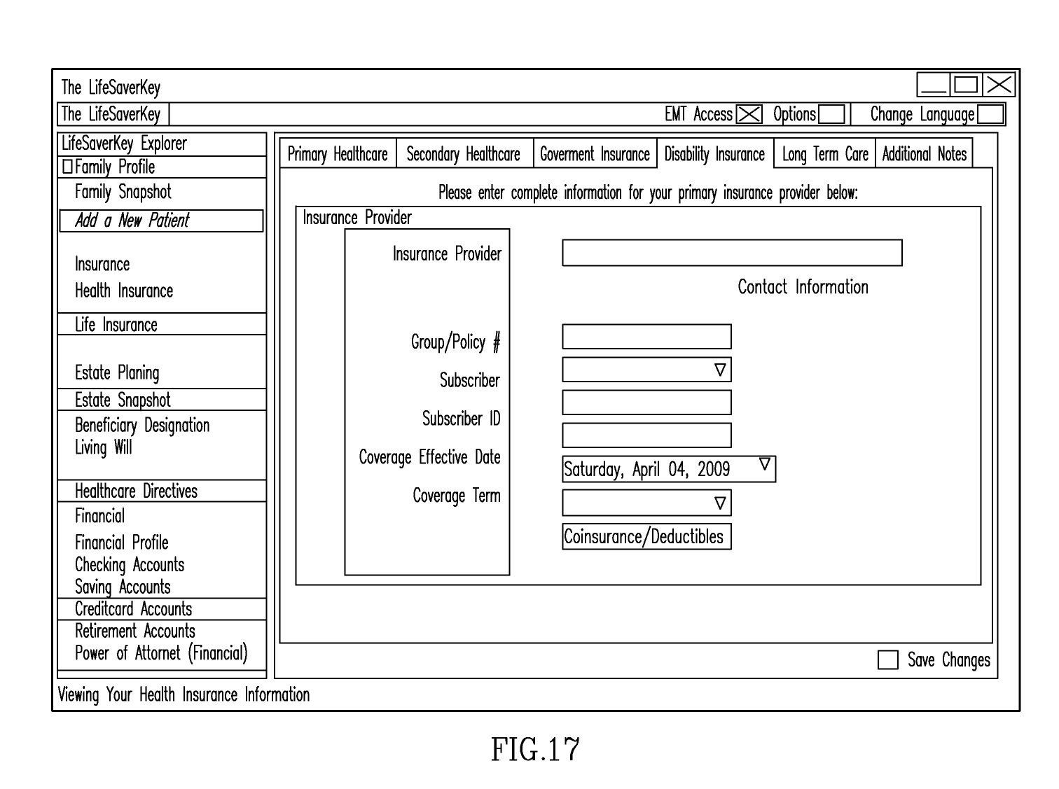

FIG. 17 is a screenshot of the disability insurance page. As in the case of the heath insurance pages, this page shows data collection fields for any disability insurance, including the provider's name, contact information and coverage dates.

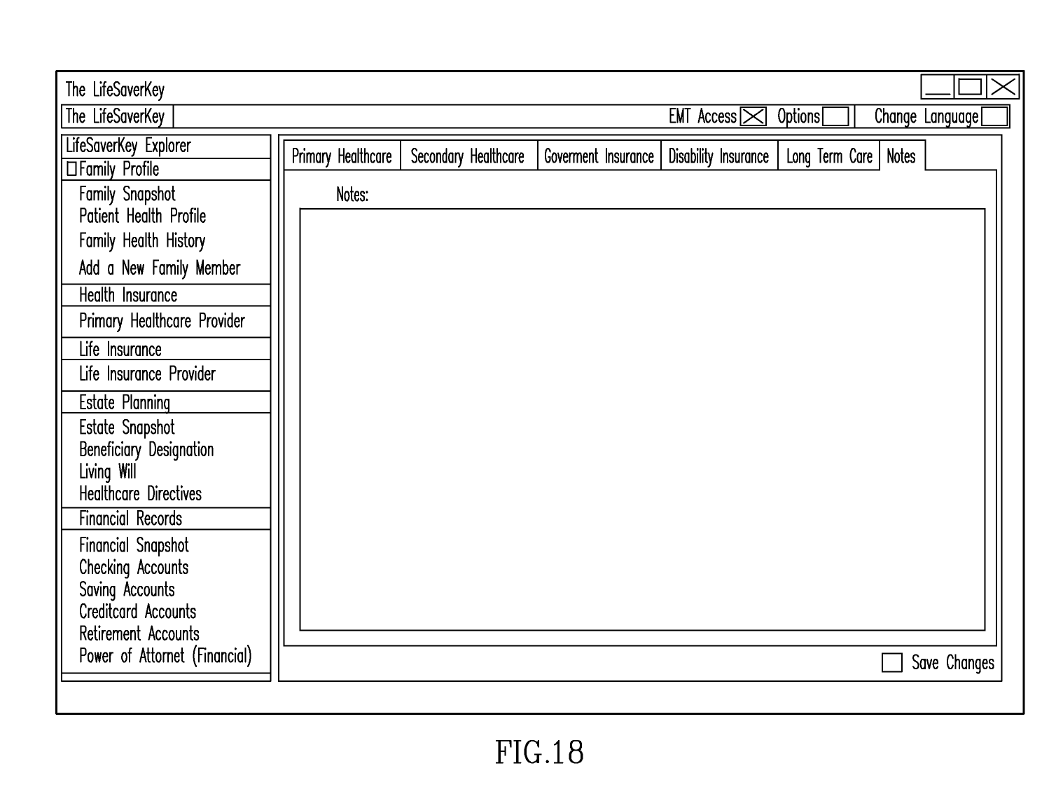

FIG. 18 is a screenshot of the notes page. In many of the menu sections, the program provides a blank page for note. Here, users can write anything that may be pertinent to them relating to the relevant menu selection.

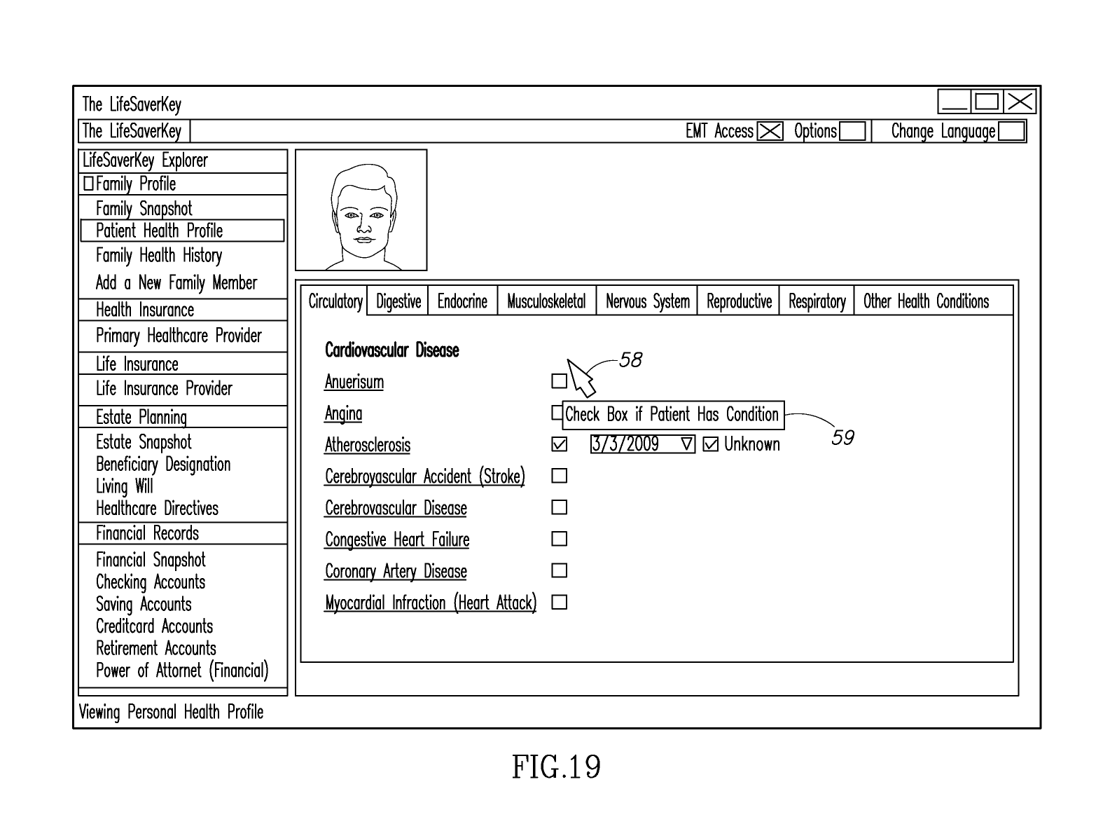

FIG. 19 is a screenshot of the patient health profile showing a selection tool tip 58. Note that the tool tip highlights a small window 59 that explains how the page is used. Here, it explains that a user should check the box if the user has a particular condition.

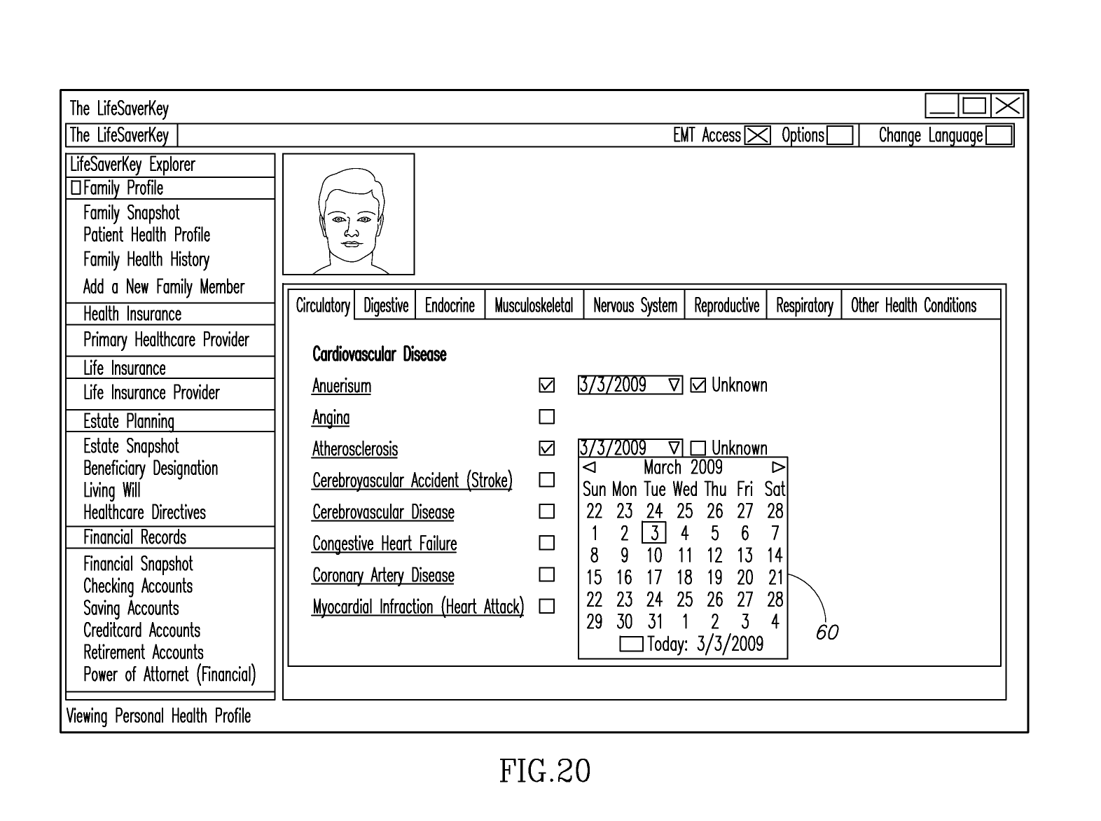

FIG. 20 is a screenshot of the patient health profile showing a pull down calendar window 60. In cases where dates must be entered, the program provides a calendar option that allows a user to select dates from the calendar, instead of typing in the date by hand.

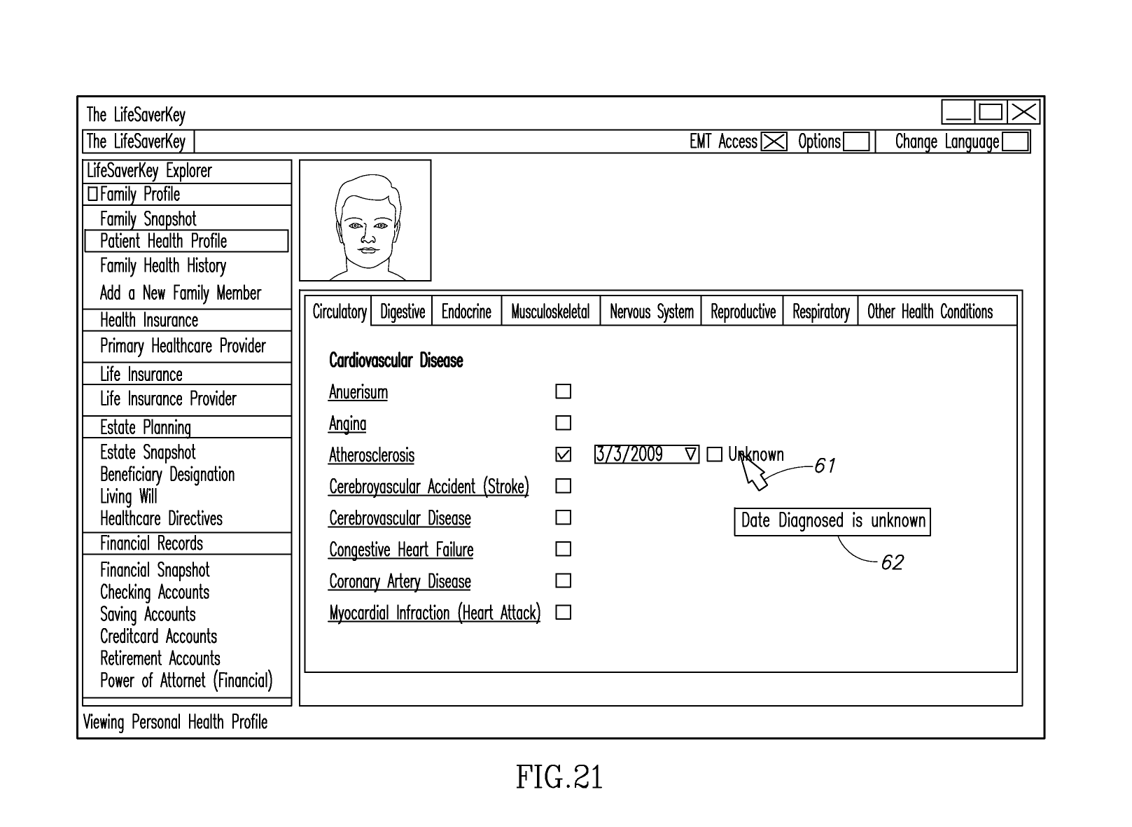

FIG. 21 is a screenshot of the patient health profile showing a second selection tool tip 61. As before, the tool tip shown has a different note 62 that helps to explain the selection box.

The other menus on the left side operate in a similar fashion. Once the information is completed, it is stored in the computer database. The device can then be inserted into a USB port on the computer and the information from the database is automatically transferred to the device. In this way, a user can carry the information in a safe, portable means that can be readily read by physicians and emergency personal even if the patient is incapacitated.

Of course, these information screens can be designed in any format. Then can also be used in other ways, such as for a pet security device. In this case, the information would relate to veterinarians, and specifics related to the pet. In any case, the information collected is stored in the device for easy retrieval.

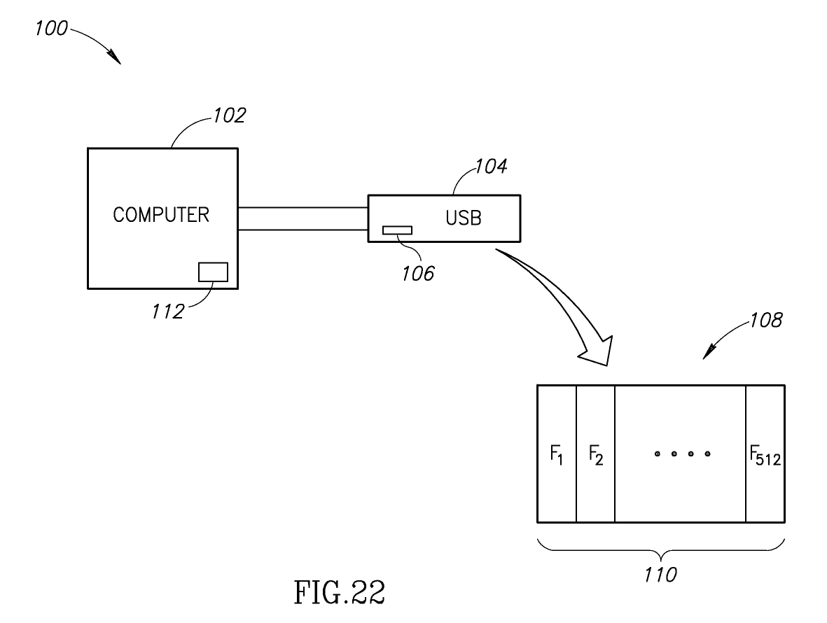

FIG. 22 shows a personal information system 100 having a computer 102 in communication with a portable media storage device 104 by way of a universal serial port (not shown). The portable media storage device 104 may take the form of a universal serial bus (USB) connector. The portable media storage device 104 is commonly referred to as a flash drive or a memory stick. In the illustrated embodiment, the portable media storage device 104 includes a proprietary identifier 106 embedded into the readable memory of the device 104. Preferably, the proprietary identifier 106 is embedded onto the device 104 before it is shipped to a customer, distributor or retailer. Further, the proprietary identifier 106 is unique for each model or type of portable media storage device 104 produced. By way of example, on the “Survivor” model the proprietary identifier could be “PEMkey, LLC Survivor.” One or more client specific software programs 112 on the computer 102 can read the proprietary identifier 106 on the device 104 and determine whether the proprietary identifier 106 is valid and legitimate. Once the computer 102 makes this verification then the computer 102 can proceed to read the personal information (not shown) stored on the device 104. The proprietary identifier 106 insures that the computer 102 synchronizes with and communicates the personal information with only verified devices 104.

Further to FIG. 22, the portable media storage device 104 includes a plurality of files 108 that prevents copying unwanted, undesired, unrelated, or irrelevant information onto the device 104 irrespective of whether such copying is being done purposefully, harmfully, or unknowingly. Because the personal information stored on the portable media storage device 104 is intended primarily for emergency purposes, it is important that the device 104 not be cluttered or burdened with irrelevant data, such as vacation photos, music libraries, etc., or even harmful data such as viruses. To provide this protection, the portable media storage device 104, after verification as discussed above, is specially configured by the computer 102. More specifically, the computer 102 configures the portable media storage device 104 so as to prevent the storage of irrelevant files after the device 104 has been synchronized with the client specific software 112 on the computer 102.

In one embodiment, the technique for preventing the storage of irrelevant files on the portable media storage device 104 takes advantage of file configuration format that allows storage of a maximum of about five-hundred and twelve entries or files 110. For illustrative purposes only, the individual files are labeled in FIG. 22 as F₁, F₂ . . . through F₅₁₂. The client specific software 112 formats the device 104 to be commensurate with the file configuration format.

Once the client specific software 112 formats the portable media storage device 104, the software 112 will “fill up” or “block off” any remaining storage capacity of the device 104 that was not used for storing the personal information. By way of example, the software 112 will convert the remaining storage capacity by configuring the unused files to a hidden format with read-only permission. Other types of non-accessible formats may also be used for the device configuration. In one embodiment, the computer 102 runs an operating system that provides the ability for a user to format or configure, as a default, certain types of files, folders or other storage space 110 as hidden and/or as read-only. Conventionally, the user could modify a setting on the computer that would allow hidden files be shown on the graphical user interface. However in the illustrated embodiment, the client specific software 112 may prevent the user from changing the file settings once the user has approved that all personal information has been properly input and organized on the computer. For example, the approval process may be similar to how a person would digitally approve and submit their tax forms online using tax software program.

Additionally, the software 112 may take advantage of long filename entries, which may be the same as or similar to VFAT filenames. The VFAT filenames combine shorter filenames into a single, long filename. The software 112 may create filenames that are approximately two-hundred and fifty-five characters long for the hidden files. Advantageously, these long filenames that are hidden or read-only reduces the amount of files that need to be or can be stored onto the device 104. In one embodiment, the long filenames start with the Omega character (Ω) because this character comes after all letters in the English alphabet and makes the hidden files appear last in cases where all files on the device 104 are viewable on the computer 102 regardless of the permissions or settings. Once all five-hundred and twelve entries on the device 104 have been filled then the computer 102 will generate an error when a user attempts to download additional files.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A personal information system comprising:
a computer station having a graphical user interface for inputting personal information to a secure database and further having a processor for managing a plurality of digital forms based on commands input by a user, wherein the personal information is selectively input by the user and the digital forms are viewable by the user via the graphical user interface; and
a portable media storage device having a housing coupled to a memory storage device, which includes a memory storage capacity for receiving the personal information stored in the database of the computer station, the memory storage device is encrypted to communicate with only the secure database, wherein an amount of the memory storage capacity is configured to be inaccessible for receiving information that is not the personal information from the secure database, and
wherein at least some of the personal information stored on the memory storage device is accessible by a health care provider during an emergency situation.

2. The personal information system of claim 1, wherein the memory storage device is a universal serial bus connector.

3. The personal information system of claim 1, wherein the housing of the portable media storage device includes a reflective cover.

4. The personal information system of claim 1, wherein the personal information includes private medical information.

5. The personal information system of claim 1, further comprising a light emitting diode (LED) located within the housing of the portable media storage device.

6. The personal information system of claim 5, wherein the LED is configured to operate intermittently when activated.

7. The personal information system of claim 1, wherein the memory storage device is retractable into and extendable from the housing.

8. A method of making a portable memory storage device for use during an emergency situation, the method comprising:
configuring a portable memory storage device to receive user-selected personal information downloaded from a secure database of a selected computer, wherein configuring the portable memory storage device includes encrypting the device to be recognizable by the selected computer and restricting the device to receive information solely from the secure database; and
configuring the portable memory storage device to store the information in an accessible memory portion of a memory of the portable memory storage device, wherein a total memory of the portable memory storage device includes the accessible memory portion and a non-accessible memory portion.

9. The method of claim 8, further comprising formatting the information in the accessible memory portion in a hidden file format.

10. The method of claim 8, wherein configuring the portable memory storage device includes configuring a universal serial bus device.

11. The method of claim 8, wherein receiving information solely from the secure database includes receiving medical history information and emergency contact information.

12. The method of claim 8, further comprising transmitting the information from the portable memory storage device during a medical emergency situation.

13. The method of claim 12, further comprising accessing the information to obtain a determination for treating a wearer of the portable memory storage device.

14. The method of claim 8, wherein encrypting the portable memory storage device includes permanently incorporating a unique identifier into the memory of the device.

15. The method of claim 8, wherein configuring the portable memory storage device includes configuring the portable memory storage device for a person.

16. The method of claim 8, wherein configuring the portable memory storage device includes configuring the portable memory storage device for an animal.
